(19) United States
(12) Patent Application Publication
(10) Pub. No.: US 2020/0339248 A1
(43) Pub. Date: Oct. 29, 2020

(54) BOUNDARY LAYER SUCTION DESIGN BY USING WINGTIP VORTEX FOR A LIFT-GENERATING BODY

(71) Applicant: PAPA ABDOULAYE MBODJ, ORLANDO, FL (US)

(72) Inventor: PAPA ABDOULAYE MBODJ, ORLANDO, FL (US)

(21) Appl. No.: 16/917,628

(22) Filed: Jun. 30, 2020

(51) Int. Cl. B64C 21/06; B64C 23/06

(52) U.S. Cl. CPC B64C 21/06; B64C 23/065

(57) ABSTRACT

A boundary layer suction design using wingtip vortex for a lift-generating body that has optimized aerodynamic performances. Holes or slots connected to the tip of the lift generating body via a plenum sucked a part of the boundary layer to delay flow transition or separation. Thus, with a more stable boundary layer, the lift is increased while the drag is reduced. Also, a valve is used to control the pressure in the plenum and optimized the suction mechanism.

### BACKGROUND OF THE INVENTION

A boundary layer surrounds any body in motion in a fluid. The viscous forces present at the surface of the body are at the origin of the boundary layer. The amount of form and skin friction drags are determined by the behavior of the boundary layer. The skin friction drag increases when there is a transition from a laminar to a turbulent boundary layer. The form drag augments when there is a flow separation with a reverse flow region in the boundary layer. Thus, controlling the boundary layer by sucking a part of it allows a reduction in skin and form drags. Also, an enhancement in the generation of lift is observed.

### BRIEF SUMMARY OF THE INVENTION

The present invention generally provides a design to reduce form, and skin friction drags on any lift-generating body. Also, it enhances the production of lift by controlling the thickness of the boundary layer via suction holes or slots present on the surface of the lift-generating body. The suction force is provided by the low-pressure area present at the tip of any lift-generating body. The holes or slots located on the surfaces of the lift-generating body are connected to the low-pressure area at the tip via a plenum embedded in the lift-generating body. When the lift is produced, the pressure gradient between the surfaces of the lift-generating body leads to the formation of a vortex at the tip of the lift-generating body. The vortex is created by the motion of the fluid from the high-pressure area that is on one surface of the lift-generating body called the intrados to the low-pressure area that exists on another surface of the lift-generating body called the extrados.

### BRIEF DESCRIPTION OF THE SEVERAL VIEWS OF THE DRAWINGS

Having described the invention in general terms, reference will be made to the accompanying drawings, which are not necessarily drawn to scale, and wherein:

FIG. 1 shows a perspective view of a lift-generating body;

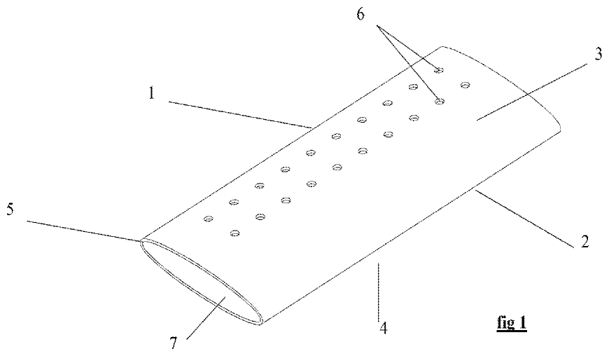

FIG. 2 shows a perspective view of the valve system installed at the tip of the lift-generating body;

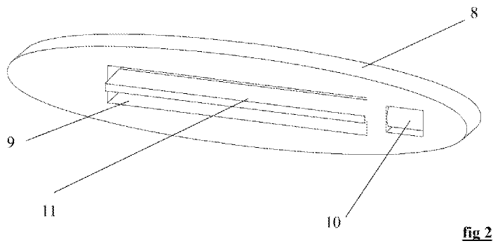

FIG. 3 shows a perspective view of a lift-generating body and the valve system installed at its tip.

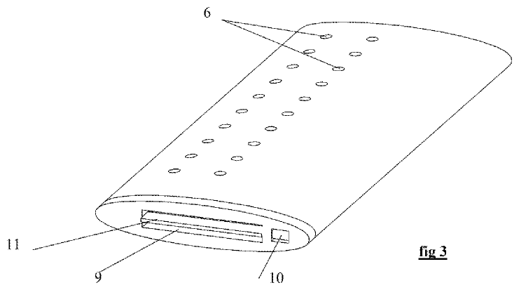

### DETAILED DESCRIPTION OF THE INVENTION

The present invention will be described more exhaustively hereinafter with reference to the accompanying drawings, in which some, but not all the embodiments of the invention are shown. Indeed, the invention may be embodied in many different forms and should not be construed as limited to the embodiments set forth herein; rather, the embodiments are provided so that the disclosure will satisfy applicable legal requirements. Like numbers refer to like elements throughout.

Lift is an aerodynamic force created by the relative motion between a body and a fluid. The body has a leading edge 1 and a trailing edge 2. The imaginary line that directly connects the leading edge 1 to the trailing edge 2 is called the chord. One surface called intrados 4 experiences a higher pressure than another surface on the body called extrados 3. This pressure gradient increases when the body's angle of attack, which is the angle between the direction of motion and the chord, augments until it reaches the critical angle of attack. At the tip of the body 5, a low-pressure area develops within a vortex. Thus, an opening at the tip of a lift-generating body 5 creates a low-pressure area inside a plenum 7 embedded in the lift-generating body and connected to the opening at the tip of the lift-generating body. Any hole or slot 6 on the surface and connected to the plenum 7 will be an area of low-pressure. When the pressure in the plenum 7 is lower than the pressure on the extrados 3 at a location where a hole or slot 6 is present, part of the boundary layer on the surface 3 will be sucked into the plenum 7 and expelled at the tip 5 of the lift-generating body.

Also, when the angle of attack is varied in a manner such that there is an inversion of the pressure gradient, meaning that 3 becomes the intrados and 4 the extrados, part of the boundary layer is still sucked into the plenum 7. If there is a sufficient pressure gradient, the design presented herein will still work. However, the boundary layer on an intrados is more stable than the boundary layer on an extrados. Thus, it is more pertinent to apply the suction on the boundary layer located on the extrados for significant gains in lift and substantial reduction of drag.

Furthermore, there is a natural corrective effect of the pressure inside the plenum while varying the angle of attack. When the angle of attack increases, the pressure inside the plenum 7 decreases because the vortex at the tip 5 gets stronger.

In specific cases, the pressure inside the plenum 7 must be regulated for optimal performance at different speeds. For such circumstances, a valve system 8 with a flap 11 is added at the tip 5.

The flap is actuated by a motor 10, changing the area 9 exposed at the tip.

The present invention applies to a wing, or rotor blade, or winglets. Many systems like compressor blades, turbines, aircraft wings, wind turbines, or pumps are made of lift-generating bodies. This invention can enhance any device acting on a fluid.

The invention claimed is:

1. An apparatus with a boundary layer suction design by using wingtip vortex for a lift-generating body, the apparatus comprising:
A lift-generating body with a tip and one surface experiencing a higher pressure than another surface;
A hole or slot placed on one of the surfaces of the lift-generating body;
A plenum embedded in the lift-generating body and connecting the hole or slot to the tip of the lift generating body;
An opening at the tip connecting a plenum the external fluid surrounding the lift-generating body.

2. The boundary layer suction design by using wingtip vortex for a lift-generating body according to claim 1, wherein multiple holes or slots are placed on the surface of the lift-generating body and are all connected to an opening at the tip of the lift-generating body via a plenum or different plenums.

3. The boundary layer suction design by using wingtip vortex for a lift-generating body according to claim 1, wherein a valve is placed at the tip of the lift-generating body and regulates the pressure inside a plenum embedded in the lift-generating body.
